(19) United States
(12) Patent Application Publication
(10) Pub. No.: US 2017/0149166 A1
(43) Pub. Date: May 25, 2017

(54) ELECTRICAL CONNECTOR ASSEMBLY

(71) Applicant: GM GLOBAL TECHNOLOGY OPERATIONS LLC, Detroit, MI (US)

(72) Inventors: Margarita Montes Mann, Royal Oak, MI (US); Stephen G. Heien, Lake Orion, MI (US); Paul Buchholz, Warren, MI (US)

(73) Assignee: GM GLOBAL TECHNOLOGY OPERATIONS LLC, Detroit, MI (US)

(21) Appl. No.: 14/951,705

(22) Filed: Nov. 25, 2015

(51) Int. Cl. H01R 13/52

(52) U.S. Cl. CPC H01R 13/5202; H01R 13/521

(57) ABSTRACT

An electrical connector assembly for attachment to a case includes a plurality of terminals, a carrier, and a single body seal. The terminals extend into a connector hole defined by the case and the carrier mates the terminals to the case. The carrier has a unibody formed as one-piece, with a sealing groove defined in the unibody. A plurality of terminal holes correspond to the terminals and extend through the unibody. The single body seal is compressed between the unibody of the carrier and a mating surface defined by the case.

### TECHNICAL FIELD

This disclosure generally relates to electrical connector assemblies, such as those used to provide polyphase power to components within sealed containers.

### BACKGROUND

Electric and hybrid powertrains include electric machines—such as motors, generators, or motor/generators—in communication with power sources. Transfer of power between the electric machines occurs via cables and connectors.

### SUMMARY

An electrical connector assembly for attachment to a case is provided. The connector assembly includes a plurality of terminals, a carrier, and a single body seal. The terminals extend into a connector hole defined by the case and the carrier mates the terminals to the case.

The carrier has a unibody formed as one-piece, with a sealing groove defined in the unibody. A plurality of terminal holes correspond to the terminals and extend through the unibody. The single body seal is compressed between the unibody of the carrier and a mating surface defined by the case, such that the interface between the carrier and the case is sealed against passage of fluids.

The above features and advantages, and other features and advantages, of the present subject matter are readily apparent from the following detailed description of some of the best modes and other embodiments for carrying out the disclosed structures, methods, or both.

### BRIEF DESCRIPTION OF THE DRAWINGS

FIG. 1 is a schematic, isometric view of an electrical connector assembly attached to a portion of a case.

FIG. 2 is a schematic, isometric view of the portion of the case with the electrical connector assembly removed or unmounted.

FIG. 3 is a schematic, isometric view of the electrical connector assembly from substantially the opposite angle of that shown in FIG. 1.

FIG. 4 is a schematic, cross-sectional view of the electrical connector assembly taken generally along a line 4-4 of FIG. 3.

### DETAILED DESCRIPTION

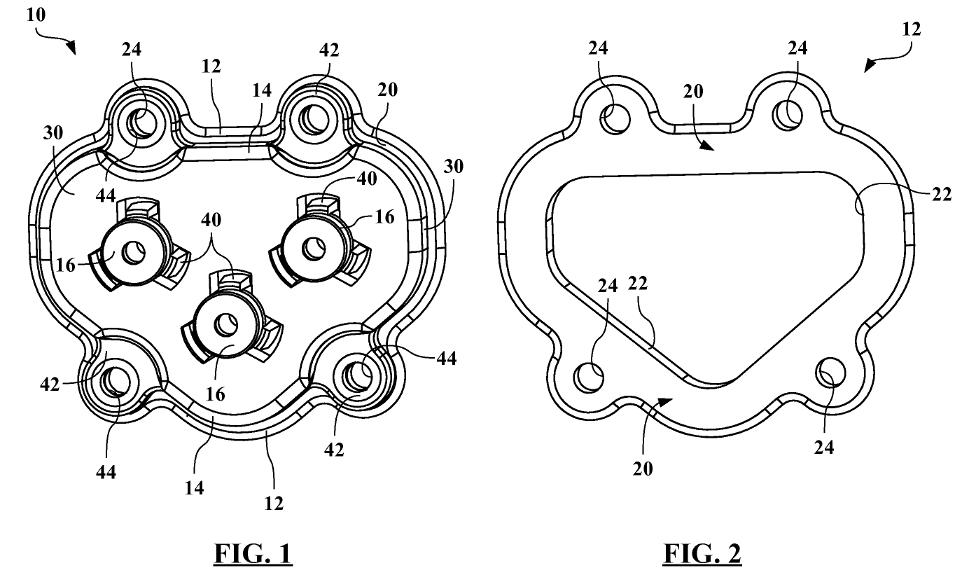

Referring to the drawings, like reference numbers correspond to like or similar components whenever possible throughout the several figures. There is shown in FIG. 1 an isometric view of an electrical connector assembly 10, which attaches or mates to a case 12. The connector assembly 10 includes a carrier 14 that aligns and mates a plurality of terminals 16 to the case 12, such that electrical connections may be made between the exterior and the interior of the case 12 via the terminals 16.

While the present disclosure may be described with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

The connector assembly 10 shown includes three terminals 16, such that it is usable for up to three-phase electrical transfer. The three-phase connector assembly 10 may be used in vehicular powertrains or other sealed electrical connections, including, for example, motor/generators disposed within fluid-filled transmissions. However, other connection arrangements for different polyphase power systems may be used, and the description herein applies to any electrical connection, particularly high voltage, into a sealed chamber.

Referring also to FIG. 2, and with continued reference to FIG. 1, there is shown an additional view of the case 12 with the carrier 14 removed or disassembled. The case 12 defines a mating surface 20 and a connector hole 22, which the connector hole 22 opens away from, and intersects, the mating surface 20. Note that only a portion of the case 12 is illustrated in the figures. In many configurations, such as where the case 12 is the housing of a transmission, the portion of the case 12 shown may be only a raised or offset portion and the connector hole 22 may be deeper than illustrated.

The terminals 16 extend into the connector hole 22 of the case 12, and may be connected directly to electrical components, such as a motor/generator, therein. A plurality of fastener holes 24 are defined in the case 12, and may receive fasteners or locator pins for aligning the carrier 14 relative to the mating surface 20.

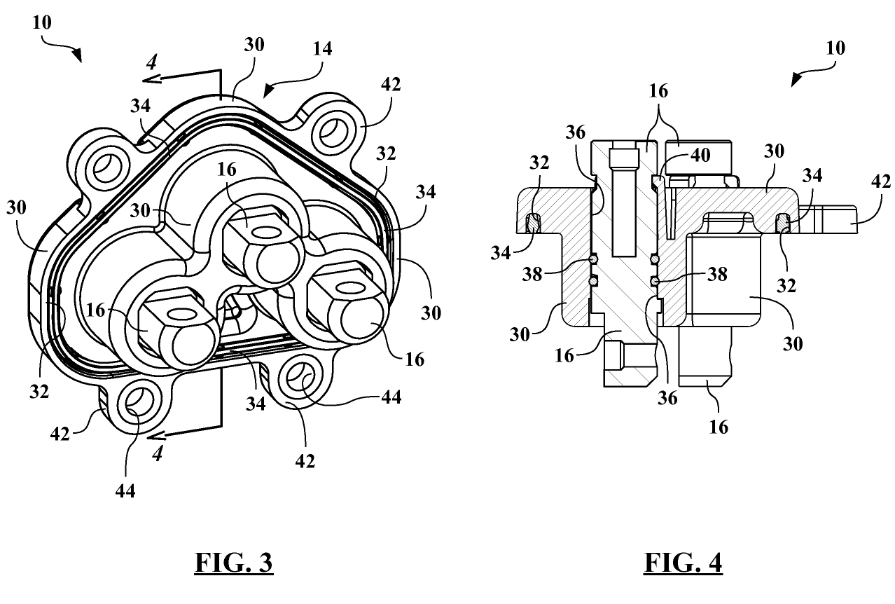

Referring also to FIG. 3 and FIG. 4, and with continued reference to FIGS. 1-2, there are shown additional views of the carrier 14. FIG. 3 shows an isometric view of the carrier 14 from the opposing side relative to the view of FIG. 1. FIG. 4 shows a partial cross-sectional view of the carrier 14, taken along a line 4-4 of FIG. 3.

The carrier 14 has a unibody 30, which is a one-piece, unitary component. One-piece components are formed as a single piece, as opposed to multiple pieces that are subsequently assembled together. Therefore, the opportunity for part errors or stacked variance problems may be reduced relative to multi-piece components.

A sealing groove 32 is defined in the unibody 30, on the side facing the mating surface 20 of the case 12, when the carrier 14 is assembled to the case 12. A single body seal 34 is disposed between the unibody 30 of the carrier 14 and the mating surface 20 of the case 12. The single body seal 34 may therefore be compressed between the unibody 30 and the mating surface 20 when the carrier 14 is assembled to the case 12.

In the configuration shown, the single body seal 34 is disposed within the sealing groove of the unibody 30. Although the sealing groove 32 is shown formed on the carrier 14, note that the sealing groove 32 may be defined in either the unibody 30 or the mating surface 20. Both the unibody 30 and the mating surface 20 are substantially planar, which promotes perpendicular mounting force and compression of the single body seal 34 between the unibody 30 and the mating surface 20.

The single body seal 34 may prevent passage of fluids or gasses between the exterior and the interior of the case 12 by sealing the interface between the unibody 30 and the mating surface 20. In many configurations, the single body seal 24 may be configured to prevent highly pressurized automatic transmission fluid from escaping the case 12.

A plurality of terminal holes 36 are defined in, and extend through, the unibody 30. The terminals 16 are disposed within terminal holes 36, such that the terminals 16 extend through the unibody 30 into the connector hole 22 of the case 12. Opposing side of the terminals 16 may be joined to high voltage electrical components, such as cables and electric machines, on both the interior and exterior of the case 12. The sealing groove 32 circumscribes the terminal holes 36, such that the single body seal 34 circumscribes the terminals 16.

In the configuration shown, the unibody 30 extends into the connector holes 22, providing relatively long terminal holes 36. However, in other configurations, the unibody 30 may not extend, or may not extend as far, into the case 12, such that the terminal holes 36 would be relatively shorter than those illustrated.

As best viewed in FIG. 4, the connector assembly 10 includes a plurality of interior seals 38 disposed between the terminals 16 and the terminal holes 36 of the unibody 30. The interior seals 38 may be, for example and without limitation, o-rings or square rings. The interior seals 38 may be disposed within grooves formed in either the unibody 30 or the terminals 16 or may be floating therebetween.

The interior seals 38 may prevent passage of fluids or gasses between the exterior and the interior of the case 12 by sealing the interface between the unibody 30 and the terminals 16. The single body seal 34 and the interior seals 38 combine to seal the connector hole 22. Therefore, the connector assembly 10 may be preassembled as a module—including the carrier 14, the terminals 16, and the single body seal 34—such that only fasteners joining the carrier 14 to the case 12 are needed to complete the connector assembly 10 and to seal the connector hole 22 of the case 12.

As best viewed in FIG. 4, and also in FIG. 1, the connector assembly 10 includes a plurality of terminal retainers 40 formed in the unibody 30 of the carrier 14. These terminal retainers 40 fixedly hold the terminals 16 within the terminal holes 36.

The terminal retainers 40 shown are flexible snap features that allow the terminals 16 to be inserted from below the unibody 30 (as viewed in FIG. 4). However other insertion directions and retention structures may be used to hold the terminals 16 to the unibody 30. For example, and without limitation, the terminal retainers 40 may be configured for a press or interference fit, or with a ridge providing interference.

The terminals 16 shown have a single connection orientation or clocking angle—due to the flat portions that engage with the electric machine. However, other terminals 16 may have two connection orientation (mirrored flats) or may be installed at any clocking angle. The unibody 30—in particularly, features of the terminal holes 36—may be configured to hold the terminals 16 at the proper clocking angle, which aligns the terminals 16 relative to the unibody 30 and to the case 12, when installed thereto.

As illustrated in FIGS. 1 and 2, the connector assembly 10 may be aligned to the connector hole 22 of the case 12 via the fastener holes 24. A plurality of locator tabs 42 generally extend from the unibody 30 over the fastener holes 24, and a plurality of locator holes 44 are defined in the locator tabs 42. Note, however, that the locator holes 44 may be defined without any tab structure extending from the unibody 30.

As illustrated in FIG. 1, each of the locator holes 44 corresponds to one of the fastener holes 24 in the case 12. Therefore, each of the locator holes 44 may be configured to receive a fastener extending through both the locator hole 44 and the fastener hole 24. Alternatively, one or more of the locator holes 44 and fastener holes 24 may have a locator pin, as opposed to a fastener, inserted there through.

In some configurations of the connector assembly 10 and case 12, asymmetric fastener holes 24 and locator holes 44 may prevent or limit misalignment of the carrier 14 relative to the case 12, such that the terminals 16 are properly aligned. In other configurations, one or more locator pegs may extend from the case 12 and cooperate with specific locator holes 44—such as differently sized or differently located locator holes 44. Where the locator holes 44 receiving fasteners are symmetric, locator pins or pegs extending between the case 12 and the carrier 14 may reduce the likelihood of misalignment of the terminals 16 within the connector hole 22.

As illustrated in the figures, the connector assembly 10 aligns each of the terminals 16 to be substantially perpendicular to the mating surface 20 of the case 12. Furthermore, all of the terminals 16 are within the same connector hole 22, as opposed to separate holes formed in the case 12, into which the individual terminals 16 would be inserted.

In the connector assembly 10 shown, the sealing groove 32 of the carrier 14 and the mating surface 20 of the case 12 are substantially planar. This allows for substantially perpendicular insertion relative to the mating surface 12, which provides even compression forces on single body seal 34 between the unibody 30 and the mating surface 20.

By positioning each of the terminals 16 within the connector hole 22 and sealing against the mating surface 20, the carrier 14 limits the amount of finishing work or detail performed on the case 12. In other configurations, such as those in which the terminals 16 are inserted into individual holes, the case 12 may need extensive finishing in order to support sealing elements directly between the terminals 16 and the case 12.

The detailed description and the drawings or figures are supportive and descriptive of the subject matter discussed herein. While some of the best modes and other embodiments for have been described in detail, various alternative designs, configurations, and embodiments exist.

1. An electrical connector assembly for attachment to a case, comprising:
a plurality of terminals extending into a connector hole defined by the case;
a carrier mating the terminals to the case, having:
a unibody formed as one-piece;
a plurality of terminal holes defined in the unibody, wherein the terminal holes extend through the unibody and correspond to the terminals; and
a sealing groove defined in the unibody, wherein the sealing groove circumscribes the terminal holes; and
a single body seal compressed in the sealing groove between the unibody of the carrier and a mating surface defined by the case.

2. The electrical connector assembly of claim 1, further comprising:
a plurality of terminal retainers formed in the unibody, wherein the terminal retainers fixedly hold the terminals within the terminal holes.

3. The electrical connector assembly of claim 2, further comprising:
a plurality of interior seals disposed between the terminals and the terminal holes of the unibody.

4. The electrical connector assembly of claim 3, further comprising:
a plurality of fastener holes defined in the unibody, wherein each of the fastener holes corresponds to one of a plurality of locator holes defined in the case and is configured to receive a fastener extending through both the fastener hole and the locator hole.

5. The electrical connector assembly of claim 4, wherein:
each of the terminals is substantially perpendicular to the mating surface of the case; and
each of the terminals is within the same connector hole of the case.

6. The electrical connector assembly of claim 5, wherein the sealing groove of the carrier is substantially planar.

7. The electrical connector assembly of claim 1, further comprising:
a plurality of interior seals disposed between the terminals and the terminal holes of the unibody.

8. The electrical connector assembly of claim 7, wherein each of the terminals is substantially perpendicular to the mating surface of the case.

9. The electrical connector assembly of claim 8, wherein the sealing groove of the carrier is substantially planar.

10. An electrical connection assembly, comprising:
a case defining:
a mating surface, wherein the mating surface is substantially planar;
a connector hole substantially perpendicular to the mating surface; and
a plurality of fastener holes;
a plurality of terminals extending into the connector hole of the case;
a carrier mating the terminals to the case, having:
a unibody formed as one-piece;
a plurality of terminal holes defined in, and extending through, the unibody, wherein the terminal holes correspond to the terminals, such that the terminals extend into the connector hole of the case; and
a plurality of locator holes corresponding to the fastener holes of the case;
a plurality of fasteners extending through the locator holes of the carrier into the fastener holes of the case, wherein the fasteners are substantially perpendicular to the mounting surface of the case;
a sealing groove defined in one of the unibody of the carrier and the mating surface of the case, wherein the sealing groove is substantially planar and circumscribes the terminals and the terminal holes of the carrier; and
a single body seal disposed within the sealing groove and compressed directly between the unibody of the carrier and the mating surface of the case.

11. The electrical connection assembly of claim 10, wherein each of the terminals is substantially perpendicular to the mating surface of the case and is within the same connector hole of the case.

12. The electrical connection assembly of claim 11, further comprising:
a plurality of interior seals disposed between the terminals and the terminal holes of the unibody.

13. The electrical connection assembly of claim 12, further comprising:
a plurality of terminal retainers formed in the unibody, wherein the terminal retainers fixedly hold the terminals within the terminal holes.
